(19) United States
(12) Patent Application Publication
(10) Pub. No.: US 2015/0132452 A1
(43) Pub. Date: May 14, 2015

(54) Frozen pizza preparation method

(71) Applicants: Michael A Weinstein, West Bloomfield, MI (US); Robert E Weinstein, Miami, FL (US)

(72) Inventors: Michael A Weinstein, West Bloomfield, MI (US); Robert E Weinstein, Miami, FL (US)

(21) Appl. No.: 14/605,378

(22) Filed: Jan. 26, 2015

Related U.S. Application Data
(63) Continuation-in-part of application No. 14/183,602, filed on Feb. 19, 2014.
Application No. 14/183,602 is a continuation-in-part of application No. 14/073,949, filed on Nov. 7, 2013, now abandoned.
(60) Provisional application No. 61/768,603, filed on Feb. 25, 2013.

(51) Int. Cl. A21D 8/06; H05B 6/64

(52) U.S. Cl. CPC A21D 8/06; H05B 6/647
USPC 426/243

(57) ABSTRACT

A frozen pizza rapid preparation method that allows an ordinary consumer to rapidly prepare a frozen pizza with a crisp crust by steps of obtaining a frozen pizza having a crust that has been baked before it has been frozen, microwave heating the pizza, transferring the pizza to a stovetop skillet, and crisping the crust on the stovetop skillet.

This application is a Continuation-in-Part Application of Ser. No. 14/183,602 filed Feb. 19, 2014, which is a Continuation-in-Part Application of Ser. No. 14/073,949, filed on Nov. 7, 2013, which claims the benefit of U.S. Provisional Patent Application No. 61/768,603, filed Feb. 25, 2013.

### BACKGROUND OF THE INVENTION

1. Field of the Invention

The present invention relates generally to methods for rapidly preparing frozen pizza.

2. Description of the Prior Art

Ordinary consumers commonly acquire frozen pizza by purchasing one that has been commercially manufactured, packaged, and distributed, and prepare the frozen pizza for consumption according to manufacturer's recommendation, thereby attaining the product intended by the manufacturer.

Presently, such purchased frozen pizzas are prepared by either baking them or microwave heating them. There are major shortcomings to both methods. Considerable time is required for the consumer to bake a frozen pizza, and microwave preparation, although faster, results in a less crisp crust when compared to baking. The unsatisfactory crusts of microwave pizzas are commonly acknowledged and are the topic of numerous innovations attempting to improve upon them.

U.S. Pat. No. 4,283,424 issued to Bone et al. discloses that: “ . . . most if not all pizza attempted to be cooked in a microwave oven have been characterized by . . . an extremely unpalatable, often soggy crust.” Bone et al. teaches a composite crust with a first layer of cracker-type dough material with 5% or less moisture and a second baked bread dough crust having a moisture content of 20-40% where the drier layer is capable of absorbing water vapor generated in microwave cooking.

U.S. Pat. No. 6,627,242 issued to McPherson, et al. similarly points out that microwaved pizza crusts are generally not pleasing to the palate, that it is difficult to generate a crisp or brown outer crust, and teaches a pizza crust comprising mesophase-gel, which when baked in a microwave oven rises in a manner similar to conventional baked-oven pizza crust, and results in a crust with a firm texture and “palatable.”

U.S. Pat. No. 5,035,903 of Huang et. al. teaches improvement in the texture of microwave heated dough products by the use of texturizing agents including surfactants, hydrogen bond-breakers, fast acting oxidants, enzymes, and disulfide-reactants.

U.S. Patent Publication 20060210673 of Petrofsky is directed to dough compositions that include a blend of fiber, hydrocolloid, methylcellulose and functional surfactants in amounts that are effective for providing a cooked dough having improved firmness after microwave cooking.

U.S. Pat. No. 5,519,195 issued to Keefer, et al. and U.S. Pat. No. 6,204,492 issued to Zeng et al. relate to susceptor devices that absorb microwave energy and have been employed to improve upon soggy microwave pizza crusts.

Despite attempts to improve upon frozen “microwave pizza,” the state of the art is reflected in the instructions accompanying many microwave pizzas that recommend baking rather than microwave heating for “best results” or to achieve a more crisp crust.

Therefore, what is needed is a frozen pizza method where a pizza can be more rapidly prepared than by baking, and where the prepared pizza has a crust akin to a baked pizza crust.

### SUMMARY OF THE INVENTION

The noted adaptations in the prior art are deficient in several ways. The provision of a portion of crust with a cracker layer to imitate the crispness of baked pizza can be expected to result in a cracker-like imitation. Frozen pizza that uses chemical additives to emulate natural foods is undesirable. There is risk of overheating and the generation of toxic materials when employing susceptors.

The choices of baking or microwaving frozen pizzas to prepare them to eat are each problematic because preparing a frozen pizza by baking is time consuming, and the crusts resulting from microwave preparation lack the texture and crispness of baked pizzas.

The present invention is for frozen pizza preparation methods that allow an ordinary consumer to prepare a frozen pizza more quickly than by baking, and with a more crisp crust than with present “frozen microwave pizzas” that are prepared by microwave heating.

Prior applications of Weinstein, Ser. Nos. 14/183,602 and 14/073,949, which are incorporated herein by reference, address this and teach means and methods for a consumer to prepare a frozen pizza where the speed of preparation is far more rapid than required for conventional oven baking of frozen pizza, and where the resulting crust is substantially more crisp and evenly heated than with present rapid methods for preparing frozen microwave pizza by microwave heating.

The applications of Weinstein teach that a microwave heating step was found to be essential to thaw and heat frozen pizza samples as rapidly as was desired. Microwave heating of samples of frozen pizza (that was manufactured with ordinary pizza dough, layered with toppings that included tomato sauce, cheese and pepperoni, and baked in a pizzeria prior to freezing) that weighed approximately 80 grams in a 1000 watt output microwave oven for about 40 seconds, was found to sufficiently thaw, heat, and melt crust and toppings. It was anticipated that larger pizza samples, pizzas having more toppings or thicker crust yet sized to fit into a microwave oven, and the use of a less powerful microwave oven, would require proportionally more time, but not exceeding about 7 minutes, representing a fraction of the time to bake a frozen pizza. Microwave heating, however, predictably resulted in a crust that was soggy and less crisp than desirable. Lifting the edges of microwave-heated test pizzas caused the soggy crust to sag. Some areas of crust were found to be more completely heated than others. Additional microwave heating to attempt to crisp the crust caused the crust to dry out and harden.

In seeking to improve upon this outcome of microwave heating, it was found that a second step of heating the microwaved pizza on an open stovetop pan more evenly heated the pizza crust and resulted in improved crust crispness. Crisping was achieved with a surprisingly short period of open skillet heating: about 30-90 seconds for a thin crust pizza weighing from about 75-300 grams. Unexpected latitude was found for crisping the microwave heated pizza crust on the stovetop pan without burning it, suggesting a preparation method suitable for lay individuals. It was anticipated that larger pizza crust surface area and thicker crust would require more time, but not more than about 3-4 minutes depending upon the cooking vessel, intensity of heat, and distance from heat source.

It is contemplated that frozen pizzas having unbaked or mostly unbaked dough, as are commonly marketed, are not suitable for the rapid methods of the present invention as they require time-consuming baking. Methods of the present invention require the consumer to acquire, preferably be directed to acquire, a frozen pizza where the crust has been sufficiently baked before freezing as to not require additional oven baking. It is contemplated that frozen pizzas of the present invention have crusts that have been sufficiently baked as to be edible without further baking, that is, almost fully or fully baked prior to freezing.

It is an objective of the present invention to allow an ordinary consumer (not a culinary expert, but rather, a purchaser of frozen pizza that essentially follows manufacturer's directions for its preparation) to quickly prepare a frozen pizza with a crisp baked pizza crust. As an example, the inventors have disclosed that when a frozen pizza that was prepared in a pizzeria to achieve a crisp crust prior to freezing was prepared for consumption by the present sequence of microwave-and-then-stovetop heating, the resulting crust had essentially the same character and crispness as before it was frozen.

It was further found that when commercially sold frozen pizzas that are instructed to be prepared by the consumer by baking, for example Tombstone Original Pepperoni Pizza, Distributed by Nestle USA, Inc., Solon, Ohio, DiGiorno Original Rising Crust Pepperoni Pizza, distributed by Nestle USA, Inc., Publix Four Cheese Crispy Crust Pizza, distributed by Publix Super Markets, Inc. Lakeland, Fla., Freschetta Brick Oven Crust Roasted Mushroom and Spinach Pizza, distributed by Schwan's Consumer Brands, Inc., of Bloomington, Minn., and Red Baron Classic Crust 4 Cheese Pizza, distributed by Schwan's Consumer Brands, were individually baked according to package instructions, frozen, and then prepared by the present microwave and stovetop sequence methods, the resulting pizza crust had essentially the same texture and crispness as after the pizza was just baked.

Microwave pizzas are presently prepared by subjecting them to microwave energy that largely heats the water within them, essentially boiling them. As noted, methods are known in the art to address this and include employment of “cracker-like” or dry elements to emulate crispness and absorb moisture, as well as chemicals to emulate ordinary dough. The inventors have sampled presently sold microwave pizzas, prepared them by microwave heating according to each manufacturer's directions, and have predictably found the resulting crusts to be less crisp than ordinary baked pizza crust, even when employing susceptors. Attempts to further crisp the crusts by heating them on a stovetop skillet, typically resulted in a cracker-like crust that was drier than the bread-like crust typical of pizza and exemplified by the inventor's pizza. Moreover, drier crust formulations are anticipated to have decreased latitude for stovetop crisping and an increased potential for burning. It was therefore recognized that the dough adaptations presently employed by manufacturers of microwave pizza are unnecessary, and may be undesirable if applied to the present invention.

Another objective of the present invention is for the user to acquire a frozen pizza crust that has been formulated by a pizza manufacturer with dough that does not acquire a cracker-like texture after it is subjected to the present methods of microwave heating followed by stovetop heating. It is therefore considered desirable for the user to acquire a packaged frozen pizza having a crust that is not adapted for methods of preparation by microwave heating alone. It is most preferred to provide a consumer with a pizza having a crust that has the characteristics of a “pizzeria-type pizza” that has been initially baked on the floor of a brick oven.

It is noted that frozen pizzas (defined as consisting of crust and toppings layered thereupon) of the present invention may include pizzas where the crusts that have been baked with toppings upon them, or pizzas where the crusts have been baked without toppings, and then toppings added, prior to freezing. It is essential that in either case, pizza toppings of the present invention be prepared in a manner commensurate with prudent culinary practice, such that microwave reheating alone suffices to prepare them for consumption. Moreover, preparation methods of the various embodiments of the present invention are intended to both allow an ordinary consumer to achieve the outcome intended by the product manufacturer, and importantly, to avoid health issues that might attend improper preparation.

The aforementioned disclosures of Weinstein further disclose desired means and methods to: a. conveniently and safely convey a pizza that has been heated in a microwave oven to a stovetop pan; or b. reduce or eliminate the need to clean a stovetop pan after it is used for crisping a pizza such as: a disposable liner for an ordinary stove top pan such that the pizza does not directly contact the pan when it is crisped; a disposable pan liner of microwave compatible material that can be utilized to underlie a pizza when it is microwave heated, transfer the pizza to a stovetop pan, and underlie the pizza crust when it is crisped upon a stovetop pan, or provision of a disposable stove top pan upon which to crisp the pizza crust; and c. along with a or b above, to unify and thereby organize the elements of the present invention for the convenience of a consumer. These are further elaborated below.

It is a further objective of the present invention for a manufacturer to provide, and/or for an ordinary consumer to obtain means to rapidly prepare frozen pizza that include a frozen pizza that is suitable for microwave and stovetop preparation, and directions to prepare the pizza for consumption by employing microwave heating, followed by stovetop heating that are appropriate for that pizza.

It is still another objective of the present invention for the manufacturer to provide, and/or the consumer obtain, a unified frozen pizza rapid preparation package that includes transfer means to transfer the pizza between microwave and stovetop modalities.

It is yet another objective of the present invention for the manufacturer to provide, and/or the consumer obtains, a unified frozen pizza rapid preparation package that includes means to heat the pizza on a stovetop pan without the need to clean the pan.

The present invention achieves these and other objectives by providing a frozen pizza preparation method that allows an ordinary consumer to prepare a frozen pizza more quickly than by baking, and with a more crisp crust than with present “frozen microwave pizzas” that are prepared by microwave heating.

In one embodiment of the present invention, there is disclosed a method for an ordinary frozen pizza consumer to rapidly prepare frozen pizza for consumption that includes obtaining a frozen pizza preparation package containing a frozen pizza having a pizza crust that has been baked prior to freezing and that has at least one topping thereon, placing the frozen pizza in a microwave oven, heating the frozen pizza in the microwave oven for a predefined period of time sufficient to heat the pizza to a temperature similar to a pizza cooked in an oven, thereby transforming the frozen pizza into a heated pizza, transferring the heated pizza into a stove top skillet, and crisping the pizza crust of the heated pizza in the stovetop skillet on a stove top.

In another embodiment of the present invention, the method includes obtaining a frozen pizza selected from the group consisting of a pizza crust and toppings thereon that have been baked together prior to being frozen, and a pizza crust that has been baked alone before application of toppings and then being frozen.

In a further embodiment, the method includes obtaining a frozen pizza having at least one or more of the following characteristics or properties. The frozen pizza characteristics or properties are a weight in the range of about 50 to 500 grams, a weight in the range of about 160 to about 320 grams, a largest dimension that measures in the range of about 6 to about 14 inches, and a crust periphery without toppings that is about ⅛ inches or greater.

In still another embodiment, the method includes obtaining a frozen pizza having a crust that has been sufficiently baked before freezing as to not require further baking.

In yet another embodiment, the method includes obtaining a frozen pizza having dough that does not acquire a cracker-like texture after microwave heating and stovetop crisping.

In another embodiment of the present invention, the method includes heating in a microwave oven for a period of time in a range of about 40 seconds to about 7 minutes or a range of about 1.5 to 3 minutes.

In a further embodiment, the method includes crisping on the stove top in the stovetop skillet for a period of time selected from the group consisting of a range of about 30 seconds to about 3 minutes and a range of about 30 seconds to about 90 seconds.

In another embodiment, the method includes obtaining a frozen pizza having a transfer substrate.

In still another embodiment, the method includes situating the frozen pizza atop a planar member of a transfer substrate and placing both into the microwave oven.

In another embodiment, the method includes employing a transfer substrate to remove heated pizza from the microwave oven and transfer the heated pizza to a stovetop skillet.

In yet another embodiment, the method includes obtaining a frozen pizza rapid preparation package containing the frozen pizza and a disposable crisping means. The disposable crisping means is one of a disposable pan liner, a transfer substrate to further line a stovetop pan, and a disposable stovetop pan.

In another embodiment, the method includes placing a disposable pan liner in the stovetop skillet, transferring a microwave heated pizza atop the disposable pan liner, and crisping the pizza crust atop the disposable pan liner in a stovetop skillet. In a further embodiment, the crisping means is an aluminum foil disposable pan liner.

In a further embodiment, the method includes transferring both a planar transfer substrate with the heated pizza thereon directly into a stovetop skillet and crisping the heated pizza in the stovetop skillet, with the transfer substrate situated between the pizza and the stove top skillet. The transfer substrate is stove-top compatible. The term “stove-top compatible” means that the transfer substrate is comprised of material that can be heated and used in a stove top skillet to crisp the pizza crust for the duration of time required to crisp the pizza crust without the stovetop heat having significant adverse effect on the transfer substrate or the transfer substrate having any adverse effect on the edibility of the pizza.

In another embodiment of the present invention, the method includes situating the frozen pizza atop a planar member of a transfer substrate and placing both into the microwave oven.

In a further embodiment, the method includes selecting a planar transfer substrate made of a material such as plastic, paper, foil-coated paper, and combinations thereof. In another embodiment, the planar transfer substrate is parchment paper.

### BRIEF DESCRIPTION OF THE DRAWINGS

FIG. 1 schematically illustrates a suitable frozen pizza preparation device that includes a pizza that is sufficiently baked as to not require further baking, microwave-stovetop sequence preparation instructions, a transfer means, and a unified packaging.

FIG. 2 is a front view to illustrate a microwave oven heating a frozen pizza upon a transfer substrate, where both are upon a rotating table inside the microwave oven.

FIG. 3 illustrates, in perspective view, the transfer of hot, microwave heated pizza to an ordinary stovetop pan where the pizza is slid from a transfer substrate onto a stovetop pan.

FIG. 4 illustrates, in perspective view, transfer of hot microwave heated pizza to a stovetop pan. The pizza is held upon the transfer substrate, and in this instance, both pizza and transfer substrate are dropped into the pan, such that the transfer substrate is interposed between the pizza crust and pan, thereby acting as both a transfer substrate and a disposable crisping means that can be disposed of after the pizza crust is crisped.

FIG. 5 illustrates, in perspective view, the transfer of hot, microwave heated pizza to an ordinary stovetop pan that is lined with a disposable crisping means such that the pizza does not directly contact the pan when it is crisped.

FIG. 6 is a diagrammatic perspective view of an alternative embodiment where a frozen pizza is depicted above a transfer substrate and where both are further above a disposable crisping means that is an inexpensive disposable pan that can be disposed of after the pizza crust is crisped. The pizza and transfer substrate are unified within the disposable pan by a cover, and microwave-crisping sequence instructions for preparation of the pizza are upon a surface of the cover.

### DETAILED DESCRIPTION OF THE PREFERRED EMBODIMENT

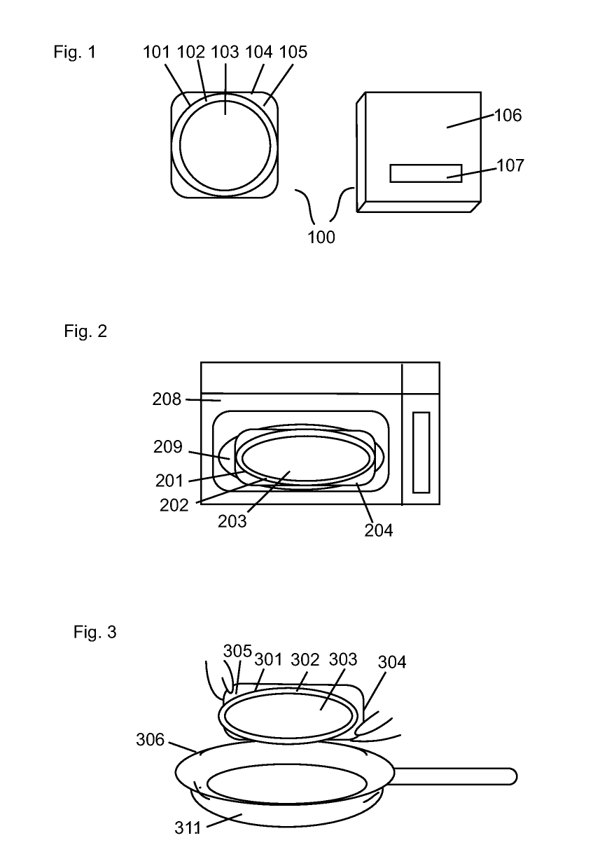

The embodiments of the present invention are illustrated in FIGS. 1-6. FIG. 1 schematically illustrates one embodiment of a frozen pizza rapid preparation package 100 of the present invention showing a frozen pizza 101 having a crust 102 and toppings 103, a transfer element or substrate 104 having a grasping adaptation 105 upon which the frozen pizza 101 is disposed. A unifying container 106 is illustrated to have microwave-crisping sequence instructions 107 for preparing the pizza upon its surface.

It is contemplated that the frozen pizza 101 has a crust 102 that has been sufficiently baked prior to being frozen as to not require substantial time for baking to prepare it for consumption. The pizza crust 102 may either have been baked with toppings 103 layered upon it, or baked without toppings 103 that are then layered upon it prior to freezing. Further, it is contemplated that the frozen pizza 101 is proportioned commensurate with preparing it in an ordinary microwave oven and ordinary stovetop pan. Therefore, frozen pizza 101 has a weight in the range of about 50 to 1000 grams, and planar dimension in the range of about 6 to about 14 inches. While a round pizza 110 is illustrated, alternative shapes are also contemplated. Pizzas that might be commonly appreciated to have a “thin-crust” or “thick-crust” are both anticipated. A peripheral area of pizza crust 102 without topping 103 is typical such that the toppings are more likely to remain upon the crust during microwave-crisping preparation.

The transfer means or substrate 104 is an element of certain embodiments of frozen pizza rapid preparation packages of the present invention. The transfer substrate 104 is illustrated to have sufficient planar dimension to underlie the pizza crust, and also to have a grasping adaptation 105 that is adequately distant from the pizza 101 that it can be grasped without touching the pizza when the pizza is hot. Variations in sizes and shapes are contemplated, both commensurate with the size and shape of the pizza, and according to desired configurations and adaptations for grasping and transferring the pizza. While planar in illustration, folded, tray-like, and otherwise dimensional embodiments are contemplated, however, such other embodiments include a planar, substantially flat surface to conform to the bottom of a pizza crust.

The transfer substrate 104 is employed by the consumer to conveniently and safely transfer hot pizza from a microwave oven to a stovetop pan. In some instances, the transfer substrate 104 may be also employed to underlie the pizza in the stovetop pan and then be disposed of after crisping, leaving a clean pan.

The unifying container 106 is depicted as a box that can incorporate the illustrated elements, however packaging variations such as wraps, bags, pouches, and panels that can incorporate the elements, which are known in the art are acceptable alternatives. It is anticipated that a portion of the unifying container, such as a panel or sheet, might be fashioned to also serve as a transfer substrate. Microwave-stovetop crisping instructions are illustrated on the surface of the illustrated box, but might otherwise be incorporated on a surface separate from the packaging container such as a sheet of paper that is incorporated in the package.

A significant advantage of such an embodiment having the simple elements of a frozen pizza that does not require baking for its preparation, a transfer means, a microwave-stovetop sequence preparation instructions, and a unifying container is its potential to inexpensively provide a far more desirable frozen pizza product than heretofore available to a consumer.

FIG. 2 is a front view illustration of a microwave oven 208 heating a frozen pizza 201, having a crust 202 and toppings 203, upon a transfer substrate 204, where both pizza 201 and transfer substrate 204 are upon a rotating table 209 inside the microwave oven 208.

It is contemplated that the time required for microwave heating will vary with the strength and configuration of the microwave oven and the size of the pizza, but will be in a range from about 40 seconds for small pizzas to about 7 minutes for very large ones. For pizzas that might be consumed by one to a few people (and weigh from about 200 to 1200 grams, and measure about 8-14 inches in largest dimension), a range of about 1.5 to 4 minutes of microwave heating on high for an ordinary microwave oven is contemplated. While moving pizzas during microwave heating and the employment of susceptors are now commonplace techniques for preparing microwave pizzas, these adaptations are optional and generally unnecessary, as the present crisping step has been found to even out the application of heat over the pizza and adequately crisp the crust.

FIG. 3 is a perspective view illustration to depict the transfer of a microwave heated pizza 301, having a crust 302 and toppings 303, to an ordinary stovetop pan 311, where the hot pizza is situated upon the transfer substrate 304 to transfer it without touching the hot pizza. The pizza is lifted from the microwave oven by holding the transfer substrate 304 and without touching the hot pizza. The transfer substrate 304 is shown being held by a grasping adaptation 305 that is sufficiently distant from the hot pizza 301 as to avoid touching the pizza.

As noted, it is contemplated that adequate crisping can be achieved with a surprisingly short period of open skillet heating at high heat: about 30-90 seconds for a thin crust pizza weighing from about 75-300 grams. It is further comtemplated that factors such as the composition and size of the pizza crusts, the cooking vessel, intensity of heat, and distance from the heat source would determine time requirement, but for ordinarily sized pizzas of about 9 inch diameter and 300 gram weight, a range of about 30 seconds to about 4 minutes is anticipated, and most likely about 30 seconds to about 2 minutes.

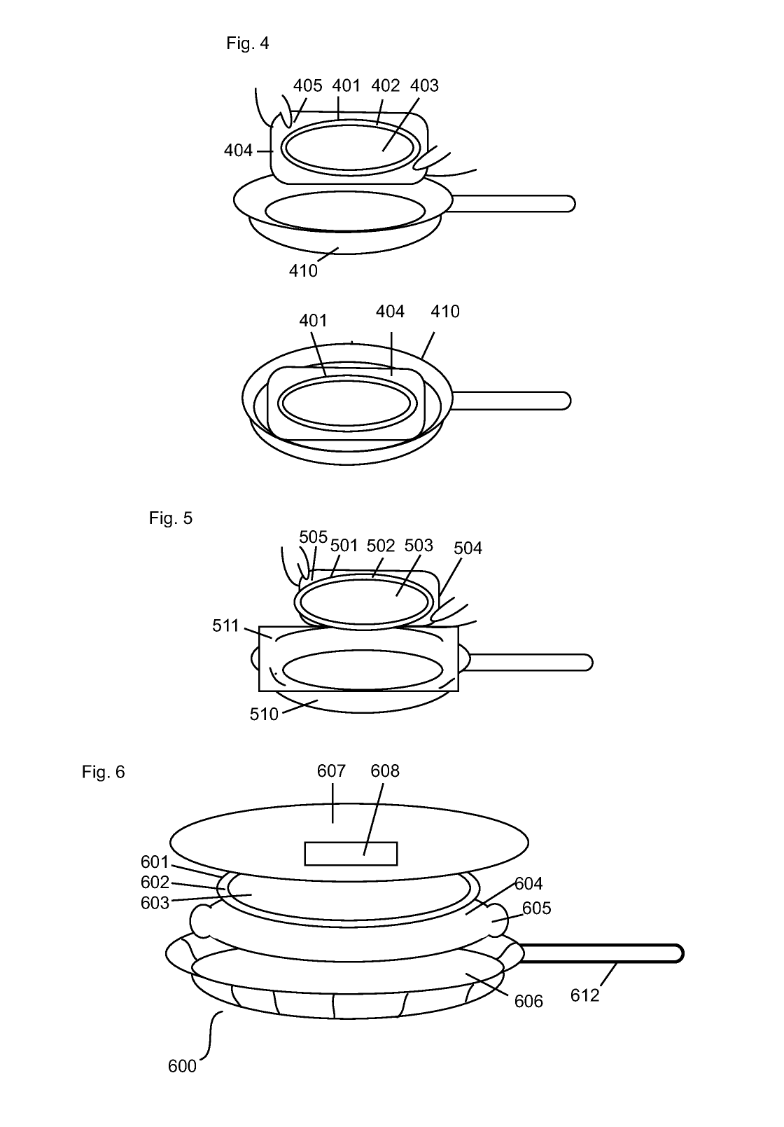

FIG. 4 is a perspective view depicting a method of transfer of a microwave heated pizza 401 to an ordinary stovetop pan 410. The illustrated transfer substrate 404 is relatively square, where the pizza 401 is round, thereby allowing the consumer to grasp the transfer element 404 at its corners, which act as a grasping adaptation away from the hot pizza. It is essential for the transfer substrate 404 to have such an area that can be grasped and that is not in direct contact with the hot pizza. Alternative configurations to underlie the pizza crust bottom and also allow grasping away from the crust are also contemplated. In this instance, the transfer substrate 420 also serves as disposable crisping means as both pizza 401 and transfer substrate 404 are placed into, or simply dropped into the pan 410, which has preferably been heated while the pizza had been in the microwave oven. The transfer substrate 404 can then be disposed of after the pizza crust is crisped.

It is shown that the transfer substrate 404 is positioned between the bottom of the pizza 401 and the stovetop pan 410 acting then as a “transfer substrate-disposable crisping means.” Following crisping, the pizza 401 can be lifted from the pan by the “transfer substrate-disposable crisping means” 404 and situated away from the pan, or slid from the stovetop pan 410 onto an ordinary plate for consumption. The transfer substrate that is also acting as a disposable crisping means 404 can then be disposed of, leaving a relatively clean stovetop pan.

It is essential that the transfer substrate 404 of this embodiment where a transfer substrate also acts as a disposable crisping means be devised of material that is both microwave and stovetop cooking compatible. It is desirable that it be inexpensive enough to qualify as disposable for ordinary consumers. It is further desirable that the material does not tend to stick to the pizza 401. It is contemplated that thermoplastic, silicon, ceramic or other suitable materials might be utilized or devised. It was found that heat resistant paper, in particular, culinary parchment paper, has the desired properties of: microwave compatibility, sufficient structural integrity to lift hot pizza from the microwave oven after microwave heating, non-stick quality, and heat resistance sufficient to withstand stovetop temperatures for the few minutes required to crisp the pizza crust. An example of parchment paper having these qualities is parchment paper distributed by Publix Super Markets, Inc. of Lakeland, Fla., and Reynolds® parchment paper, a product of Reynolds Kitchens, Richmond, Va., and both are considered to represent this genre. We have found that these materials stay intact when positioned under a pizza crust while it is crisped at full stovetop heat for a few minutes. In the event of prolonged crisping, some paper charring has been noted that we have found relatively effortless to wipe off the pan.

FIG. 5 depicts, in perspective view, the transfer of hot, microwave heated pizza 501 to an ordinary stovetop pan 510 that is lined with a disposable crisping means 511 that is a pan liner such that the pizza 501 does not directly contact the pan when it is crisped over heat (crisping over heat not illustrated). The pizza 501 is slid from a transfer substrate 504 onto the disposable crisping means 511 rather than directly onto the pan surface. While illustrated as square in shape, shapes and sizes of such pan liners 510 are contemplated to vary according to the size and shape of the pizza and crisping pan. The disposable crisping means 511, when incorporated into embodiments of a frozen pizza rapid preparation package, can be thrown away after the pizza crust 501 is crisped, leaving a relatively clean pan 510. The disposable crisping means 511 is intended to be inexpensive enough for an ordinary consumer to allow a single use. Ordinary aluminum foil is one choice of material, and Reynolds Wrap, or Reynolds Wrap non-stick, both products of Reynolds Kitchens, Richmond, Va., are examples of useable materials.

FIG. 6 is a diagrammatic perspective view of an alternative embodiment 600 where a frozen pizza 601, having a crust 602 and toppings 603, is depicted above a transfer substrate 604 having a grasping adaptation 605 and where both are further above a disposable crisping means that is an inexpensive disposable pan 606 that can be disposed of after the pizza crust is crisped. The pizza and transfer substrate are unified within the disposable pan by a cover 607, and microwave-crisping sequence instructions 608 for preparation of the pizza are upon a surface of the cover.

In practice, the consumer follows the microwave-crisping instructions 608 by removing the cover 607 and placing the pizza 601 upon the transfer substrate 604 in a microwave oven to be microwave thawed and heated (not illustrated). The instructions 608 further instruct removing the pizza 601 and the transfer substrate 604 from the microwave oven by grasping the transfer substrate 604 by its grasping means 605 and placing the pizza 601 into the disposable crisping means 606 that a disposable stovetop pan with a handle 612, and crisping the pizza crust 602 over stovetop heat (crisping over heat not illustrated).

The disposable crisping means 606 is sufficiently inexpensive for an ordinary user to dispose of it after a single use. One example of a single-use stovetop heating pan is the folded-sheet aluminum pan of the “Jiffy Pop” popcorn package, a product of ConAgra Foods. The crusts of microwave thawed and heated frozen pizza samples have been satisfactorily crisped utilizing this pan. Modifications are contemplated as in size and shape of the disposable heating vessel to include size and shape to fit pizzas, reconfiguration(s) of the bottom of the device, for example, to elevate the pizza crust above direct heat, and variations in means for grasping the pan. Also, a range of instruction as to technique for crisping the pizza crust are contemplated, for example, heating directly on the stovetop, raising the pan above the stovetop, heating the pizza crust with the pan stationary, or moving it during crisping, shaking the pan to move the pizza within such that the pizza does not stick to the pan, and range of cooking heat and cooking time, all of which are within the scope of the invention.

The present invention teaches means and methods to provide a consumer with a frozen pizza package, where the pizza can be more quickly prepared than by baking, and where a more crisp and evenly heated crust is achieved in comparison to microwave-prepared frozen pizzas.

Although the preferred embodiments of the present invention have been described herein, the above description is merely illustrative. Further modification of the invention herein disclosed will occur to those skilled in the respective arts and all such modifications are deemed to be within the scope of the invention as defined by the appended claims.

What is claimed is:

1. A method for an ordinary frozen pizza consumer to rapidly prepare frozen pizza for consumption, the method comprising:
obtaining a frozen pizza rapid preparation package comprising a frozen pizza having a pizza crust that has been baked prior to freezing and that has at least one topping thereon;
placing the frozen pizza in a microwave oven;
heating the frozen pizza in the microwave oven for a predefined period of time sufficient to heat the pizza to a temperature similar to a pizza cooked in an oven, thereby transforming the frozen pizza into a heated pizza;
transferring the heated pizza into a stove top skillet; and
crisping the pizza crust of the heated pizza in the stovetop skillet on a stove top.

2. The method of claim 1 wherein the obtaining step includes obtaining a frozen pizza selected from the group consisting of a pizza crust and toppings thereon that have been baked together prior to being frozen, and a pizza crust that has been baked alone before application of toppings and then being frozen.

3. The method of claim 1 wherein the obtaining step includes obtaining a frozen pizza having a characteristic selected from the group consisting of a weight in the range of about 50 to 500 grams, a weight in the range of about 160 to about 320 grams, a largest dimension that measures in the range of about 6 to about 14 inches, and a crust periphery without toppings that is about ⅛ inches or greater.

4. The method of claim 1 wherein the obtaining step includes obtaining a frozen pizza having a crust that has been sufficiently baked before freezing as to not require further baking.

5. The method of claim 1 wherein the obtaining step includes obtaining a frozen pizza having a dough that does not acquire a cracker-like texture after microwave heating and stovetop crisping.

6. The method of claim 1 wherein the heating in the microwave oven step includes heating for a period of time selected from the group consisting of a range of about 40 seconds to about 7 minutes and a range of about 1.5 to 3 minutes.

7. The method of claim 1 wherein the crisping step includes crisping on the stove top in the stovetop skillet for a period of time selected from the group consisting of a range of about 30 seconds to about 3 minutes and a range of about 30 seconds to about 90 seconds.

8. The method of claim 1 wherein the obtaining step includes obtaining a frozen pizza rapid preparation package further comprising a transfer substrate.

9. The method of claim 8 wherein the placing step includes situating the frozen pizza atop a planar member of a transfer substrate and placing both into the microwave oven.

10. The method of claim 8 wherein the heating step includes heating the frozen pizza in a microwave oven for a period of time selected from the group consisting of a range of about 40 seconds to about 7 minutes and a range of about 1.5 to 3 minutes.

11. The method of claim 8 wherein the transferring step and the crisping step includes employing a transfer substrate to remove heated pizza from the microwave oven and transfer the heated pizza to a stovetop skillet.

12. The method of claim 8 wherein the obtaining step includes obtaining a frozen pizza rapid preparation package containing [the frozen pizza and] a disposable crisping means selected from the group consisting of a disposable pan liner, a transfer substrate to further line a stovetop pan, and a disposable stovetop pan.

13. The method of claim 12 wherein the transferring step and the crisping step includes placing a disposable pan liner in the stovetop skillet, transferring a microwave heated pizza atop the disposable pan liner, and crisping the pizza crust atop the disposable pan liner in a stovetop skillet.

14. The method of claim 12 further comprising selecting an aluminum foil disposable pan liner as the disposable crisping means.

15. The method of claim 12 wherein the transferring step and the crisping step includes transferring both a planar transfer substrate with the heated pizza thereon directly into a stovetop skillet and crisping the heated pizza in the stovetop skillet, with the transfer substrate situated between the pizza and the stove top skillet, the transfer substrate being of stove-top compatible material.

16. The method of claim 15 further comprising selecting a planar transfer substrate made of a material selected from the group consisting of plastic, paper, foil-coated paper, and combinations thereof.

17. The method of claim 16 further comprising selecting a planar transfer substrate that is parchment paper.

18. The method of claim 12 wherein the transferring step and the crisping step includes employing a transfer substrate to transfer microwave heated pizza to a disposable stovetop pan and crisping the pizza crust in the disposable stovetop pan.

19. The method of claim 1 wherein the obtaining step includes obtaining a frozen pizza rapid preparation package containing the frozen pizza and a disposable crisping means that is a disposable stovetop pan.

20. A method for an ordinary consumer to rapidly prepare frozen pizza for consumption, the method comprising:
obtaining a frozen pizza rapid preparation package comprising:
a frozen pizza having a pizza crust that has been sufficiently baked as to be suitable for consumption prior to freezing, and having at least one topping upon the pizza crust;
microwave-crisping sequence instructions that instruct sequential steps of heating the frozen pizza in a microwave oven followed by crisping the pizza crust on a heated stovetop pan;
means to transfer the hot microwave-heated pizza from the microwave oven to a stovetop pan; and
unifying packaging that unifies the frozen pizza, sequence instructions, and transfer means;
removing the frozen pizza and transfer means from the frozen pizza rapid preparation package;
placing the frozen pizza upon the transfer means in a microwave oven;
heating the frozen pizza in the microwave oven for a predefined period of time;
using the transfer means to transfer the heated pizza from the microwave oven to a stovetop pan; and
crisping the pizza crust on a heated stovetop pan for a predefined period of time.

21. The method of claim 20 wherein the microwave heating step includes heating for a period of time selected from the group consisting of a range of about 40 seconds to about 7 minutes and a range of about 1.5 to 3 minutes.

22. The method of claim 20 wherein the stovetop crisping step includes crisping on the stove top in the stovetop skillet for a period of time selected from the group consisting of a range of about 30 seconds to about 3 minutes and a range of about 30 seconds to about 90 seconds.
